(19) United States
(12) Patent Application Publication
(10) Pub. No.: US 2018/0048043 A1
(43) Pub. Date: Feb. 15, 2018

(54) RADIO FREQUENCY FILTER HAVING CAVITY STRUCTURE

(71) Applicant: KMW INC., Hwaseong-si (KR)

(72) Inventors: Nam-Shin PARK, Hwaseong-si (KR); Byeong-Chul KIM, Osan-si (KR); Dae-Soo JEONG, Gwangju-si (KR)

(73) Assignee: KMW INC.

(21) Appl. No.: 15/789,953

(22) Filed: Oct. 20, 2017

Related U.S. Application Data
(63) Continuation of application No. PCT/KR2016/001537, filed on Feb. 16, 2016.

(30) Foreign Application Priority Data
Apr. 20, 2015 (KR) 10-2015-0055070

(51) Int. Cl. H01P 1/207; H01P 7/06

(52) U.S. Cl. CPC H01P 1/207; H01P 7/06

(57) ABSTRACT

The present disclosure provides a radio frequency filter having a cavity structure including a housing, a cover and a resonance element. The housing has a hollow interior for providing a cavity, and an open side. The cover shields the open side of the housing. The resonance element is positioned in the hollow interior of the housing, and has a planar portion and a support for supporting and fixing the planar portion to the housing. The planar portion of the resonance element has at least two through holes, and the support has a lower end portion formed with a male thread structure for screw fastening. The housing is formed with a female thread structure to be screw fastened with the male thread structure formed at the lower end portion of the support.

### TECHNICAL FIELD

The present disclosure in some embodiments relates to a radio signal processing apparatus used in a radio communication system. More particularly, the present disclosure relates to a radio frequency filter having a cavity structure such as a cavity filter.

### BACKGROUND

A radio frequency filter having a cavity structure generally utilizes a metallic housing for providing a plurality of accommodation spaces or cavities having a shape such as rectangular parallelepiped and the like, in which dielectric resonance elements (DR) or resonance elements having a metallic resonance rod are each provided for generating superhigh frequency resonance. Some radio frequency filters employ a structure that generates resonance by the shape of the cavity itself without using the dielectric resonance element. Further, a radio frequency filter having such a cavity structure is generally provided at its upper portion with a cover for shielding the open areas of the corresponding cavities, where the cover may have, as a configuration for tuning the filtering characteristic of the radio frequency filter, a plurality of tuning screws and nuts for fixing the corresponding tuning screws. An example radio frequency filter having a cavity structure is disclosed in Korean Patent Application Publication No. 10-2004-100084 (entitled “Radio Frequency Filter” and published on Dec. 2, 2004; inventors: Park, Jonggyu et al.) filed by the present applicant.

Radio frequency filters having such a cavity structure are used for processing radio transmit signals and receive signals in a radio communication system. Particularly in mobile communication systems, they are typically used for base stations, repeaters or relays and the like.

Meanwhile, a base station or a repeater of a mobile communication system usually comprises an antenna device installed on a pole at a high place from the ground and a main unit linked to such an antenna unit typically through a cable. In recent years, owing to continued technology development for weight reduction and miniaturization of equipment units for processing radio signals, an installation method in use involves installing at least some modules of the main units on a mounting pole for the antenna device, and arranging the modules to be directly linked with or included in the antenna device.

Therefore, in manufacturing a radio frequency filter applicable for use with such a base station or a repeater of the mobile communication system, miniaturization and weight reduction are emerging as more important considerations.

However, the radio frequency filter having a cavity structure suffers from limitations in providing desired weight reduction and miniaturization because the filter needs to be structured for providing a housing typically with a resonance element installed and to basically have a coupling structure of the housing with a cover. Further, considering a filter design that reduces the overall dimension of the cavity and the resonance element for light weight and miniaturization, the mechanical shapes and sizes required to stably and fixedly couple and install the resonant element in the cavity counteract weight reduction and miniaturization of the radio frequency filter.

### DISCLOSURE

### Technical Problem

Therefore, at least one embodiment of the present disclosure seeks to provide a radio frequency filter having a cavity structure that can be made more compact and lightweight.

In another embodiment, the present disclosure seeks to provide a radio frequency filter for minimizing the mechanical form and size required to stably fix and couple the resonant element in the cavity.

### SUMMARY

In accordance with some embodiments of the present disclosure, a radio frequency filter having a cavity structure includes a housing, a cover and at least one resonance element. The housing is configured to have a hollow interior for providing at least one cavity, and an open side. The cover is configured to shield the open side of the housing. The at least one resonance element is positioned in the hollow interior of the housing and has a planar portion and a support fixed to the housing and supporting the planar portion. The planar portion of the at least one resonance element has at least two through holes formed so as to be connected to an external driver device and rotate a corresponding resonance element, and the support has a lower end portion formed with a male thread structure for screw fastening. And the housing is formed with a female thread structure to be screw fastened with the male thread structure formed at the lower end portion of the support for fixing the support.

The external driver device may include at least two pins configured to be at positions corresponding to the at least two through holes formed in the planar portion, and to be inserted in the at least two through holes for an engagement with the at least two through holes.

### Advantageous Effects

As described above, a radio frequency filter having a cavity structure according to at least one embodiment of the present disclosure can be made more compact and lightweight. The radio frequency filter has minimized mechanical form and size required to stably fix and couple the resonant element within the cavity, and it can be made in a plain, simplified structure.

In addition, there is an advantage that the miniaturized and lightweight radio frequency filter can be easily installed in a station such as a base station.

### BRIEF DESCRIPTION OF THE DRAWINGS

FIG. 1 is a partially exploded perspective view of a radio frequency filter having a cavity structure according to a first embodiment of the present disclosure.

FIG. 2 is a sectional view taken along line A-A′ of the radio frequency filter in FIG. 1.

FIG. 3 is a diagram illustrating an installation work performed on a resonance element in the radio frequency filter in FIG. 2.

FIG. 4 is a partially exploded perspective view of a radio frequency filter having a cavity structure according to a second embodiment of the present disclosure.

FIG. 5 is a partial sectional view taken along line A-A′ in FIG. 4.

### DETAILED DESCRIPTION

Some embodiments of the present disclosure will now be described in detail with reference to the accompanying drawings.

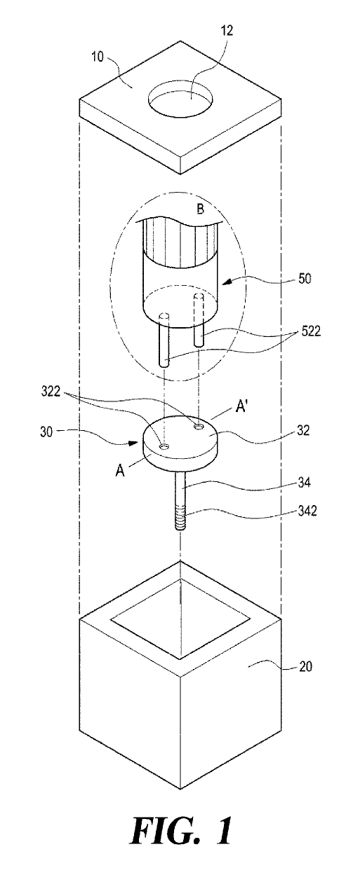

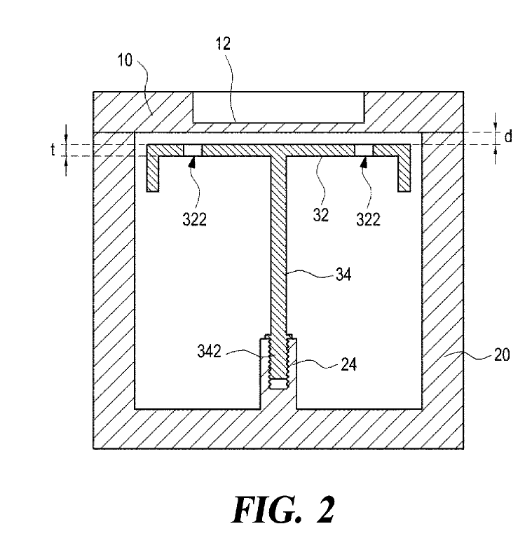

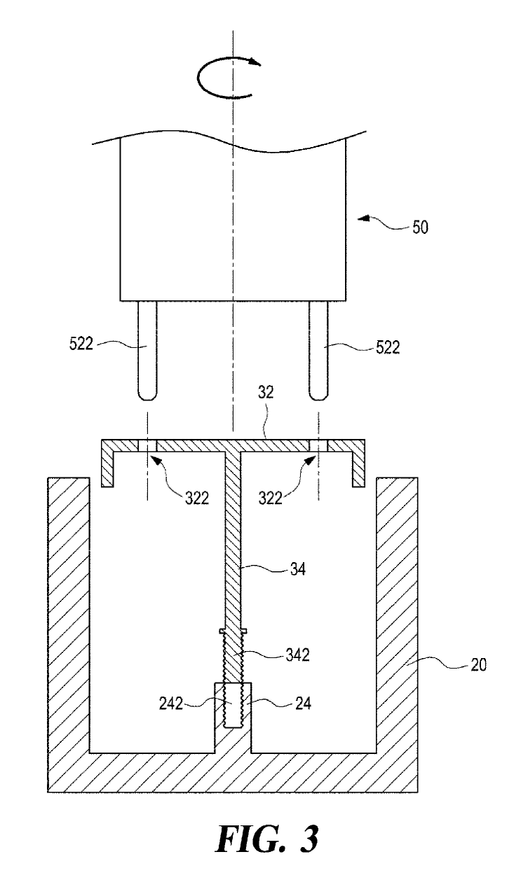

FIG. 1 is a partially exploded perspective view of a radio frequency filter having a cavity structure according to a first embodiment of the present disclosure, wherein the dot-dash circle shows an additional driver device 50 as a work tool for the installation work of a resonance element 30 for the sake of convenience of explanation. FIG. 2 is a sectional view taken along line A-A′ of the radio frequency filter in FIG. 1, which is completely assembled. FIG. 3 is a diagram illustrating the installation work performed on the resonance element in the radio frequency filter in FIG. 2 before its housing 20 is fitted with a cover 10 shown in FIG. 2.

Referring to FIGS. 1 to 3, the radio frequency filter having the cavity structure according to the first embodiment of the present disclosure, similar to prior art, is provided with an enclosure that has at least one cavity which is hollow inside and is isolated from the outside. The enclosure is formed including the housing 20 having at least one cavity and an opening on one side (for example, the upper side), and the cover 10 for shielding the open side of the housing 20. FIGS. 1 to 3 illustrate an example basic structure where, for example, a single-cavity structure is formed in the housing 20. In addition, such a cavity is provided with one resonance element 30, for example, at the center thereof. The housing 20 may be formed, on two side surfaces, with additional input/output terminals (not shown) of a usual structure for signal input/output to and from the radio frequency filter.

The housing 20 and the cover 30 may be made of a material such as aluminum (alloy) or others, and in order to improve the electrical characteristics, at least the surface forming the cavity may be plated with silver or copper. The resonance element 30 may also be made of a material such as aluminum (alloy), iron (alloy) or others, and it may be plated with silver or copper.

The physical structure of the cavity formed in the housing 20 and in the cover 10 of the radio frequency filter according to the first embodiment of the present disclosure and the installment of the resonance element 30 inside the cavity may appear to be relatively similar to the prior art, except that they can be miniaturized in implementation. The improvement over the conventional structure, however, is in the resonant element 30 and the installation thereof, according to at least one embodiment of the present disclosure.

More specifically, the resonant element 30 includes a planar portion 32 that forms, in terms of circuitry, a capacitor (C) component of the filter and has, for example, a circular planar shape. The resonant element 30 additionally includes a rod-like support 34 that forms, in terms of circuitry, an inductor (L) component and has a circular cross section. The support 34 has an upper end portion formed to merge with the planar portion 32 at its bottom side and a lower end portion installed fixedly and coupled with the enclosure, i.e., the housing 20 to support the planar portion 32.

In the above, the lower end portion of the support 34 of the resonance element 30 is formed with a male thread structure 342 as a means for threaded coupling. In an arrangement complementary to the male thread structure 342, the housing 20 is provided with a female thread structure 24 to be screw connected to the male thread structure 342 formed at the lower end portion of the support 34 for fixing the latter. The female thread structure 24 is formed, for example, to protrude from the housing 20 at a portion corresponding to the bottom surface of the cavity.

At least two through holes 322 are appropriately formed in the planar portion 32 of the resonance element 30 at points symmetrical to each other with respect to, for example, the center of the planar portion 32. The through holes 322 are configured to engage, when performing the installation work of the resonance element 30, an external device, that is, the driver device 50 for rotating the resonance element 30, and thereby the male thread structure 342 formed on the support 34 of the housing 30 is screwed into the internal threaded structure 24.

The driver device 50 has at least two coupling pins 522 disposed at locations corresponding to at least two through holes 322 formed in the planar portion 32 of the resonance element 30, and having a suitable size and a shape for being inserted into the through holes 322 to establish an interconnection therebetween, as shown in FIGS. 1 and 3. With the driver device 50, an operator may rotate the relevant resonance element 30, for example, in a clockwise direction by inserting the coupling pins 522 of the driver device 50 into the through holes 322 of the planar portion 32 of the resonance element 30. As a result, the male thread structure 342 of the support 34 of the resonance element 30 is tightened to the female thread structure 24 of the housing 20, whereby the resonance element 30 is installed on the bottom surface of the housing 20.

In terms of installation, the above-described method with the resonance element 30 seems somewhat similar to ordinary method of screw interconnection. However, different from the construction of the embodiments of the present disclosure, employing the ordinary method of screw interconnection alone would lead to a conceptual structure with a slot screw drive or a cross screw drive formed centrally of the planar portion 32 of the resonance element 30 so that the drive can engage a typical screwdriver. Such conceptual structure requires the planar portion 32 to have a relatively large thickness in order to form grooves into the aforementioned slot screw drive or cross screw drive. In comparison, according to some embodiments of the present disclosure, the structure forming the through hole 322 is configured to make the planar portion 32 of the resonance element 30 very thin.

Of the resonance element 30, the planar portion 32 and the support 34 form the C component and the L component of the relevant filter, respectively. For example, in order to reduce the filter size while maintaining the same L value as compared with a filter of a larger size, the support 34 needs to be designed to have a small diameter. In some embodiments of the present disclosure, the thickness of the planar portion 32 of the resonance element 30 is designed to be very thin, and at the same time, the support 34 of the resonance element 30 required to stably support the planar portion 32 can be designed to have a diameter further reduced. For example, the thickness (reference symbol ‘t ’ in FIG. 2) of the planar portion 32 may be designed to be, for example, about 0.5 mm or less. In addition, the planar portion 32 of the resonance element 30 may be installed close to the cover 10 to increase the value of C component. For example, the distance (reference symbol ‘d’ in FIG. 2) between the planar portion 32 and the cover 10 may be designed to be about 0.5 mm. In the example of FIG. 2 at least, additional extensions formed are illustrated as extending somewhat further downward along the sides of the cavity from the side edges of the planar portion 32, and these extensions help to increase the value of C of the planar portion 32.

In addition, the resonance element 30 may be silver-plated after it is generally made of a material such as iron (alloy) according to some embodiments of the present disclosure, which is to compensate for characteristic changes due to changes in the temperature of the filter. Specifically, in the environment of using the radio frequency filter, the sizes of the cavity and the resonant element expand as a whole as the temperature rises, which makes the center frequency of the filter deviated to the lower band. In some embodiments of the present disclosure, the resonance element is made of a material having a smaller thermal expansion coefficient (for example, iron) than the material of the housing and the cover (for example, an aluminum alloy) to increase the distance between the cover and the resonance element when the temperature rises, whereby compensating for the center frequency of the relevant filter deviating to the lower band. The resonance element 30 may be made of other materials such as copper (Cu), brass (Bs) or the like which has a thermal expansion coefficient lower than that of the aluminum alloy.

The cover 10 may have a structure similar to that aoolicable to the typical radio frequency filter with a cavity structure. For example, the structure may be similar to that of Korean Laid-Open Patent Publication No. 10-2014-0026235 (entitled ‘Radio Frequency Filter with Cavity Structure’, published Mar. 5, 2014, and invented by PARK, Nam Sin et. al.) filed by the present applicant. Korean

Laid-Open Patent Publication No. 10-2014-0026235 discloses a simplified filter structure for enabling frequency tuning without using a rather usual coupling structure of tuning screws and fastening nuts. The cover 10 according to some embodiments of the present disclosure is formed with one or a plurality of recessed or depression structures 12 as disclosed by Korean Laid-Open Patent Publication No. 10-2014-0026235. Frequency tuning can be performed by forming a plurality of dot peens by marking or pressing the depression structures 12 with marking pins of an external marking device.

According to other embodiments of the disclosure, on the one hand, a more generalized frequency tuning scheme is applied to the cover 10 so as to form a frequency tuning screw and a fastening nut without such an arrangement as the aforementioned depression structures 12. The structure including the frequency tuning screw and the fastening nut described above, however, is relatively complicated to possibly make their miniaturization difficult. In addition, as the interval between the cover 10 and the resonant element 30 is designed to be smaller, the tuning is more difficult, so it may not be easy to adopt the structure comprising the tuning screw and the fastening nut.

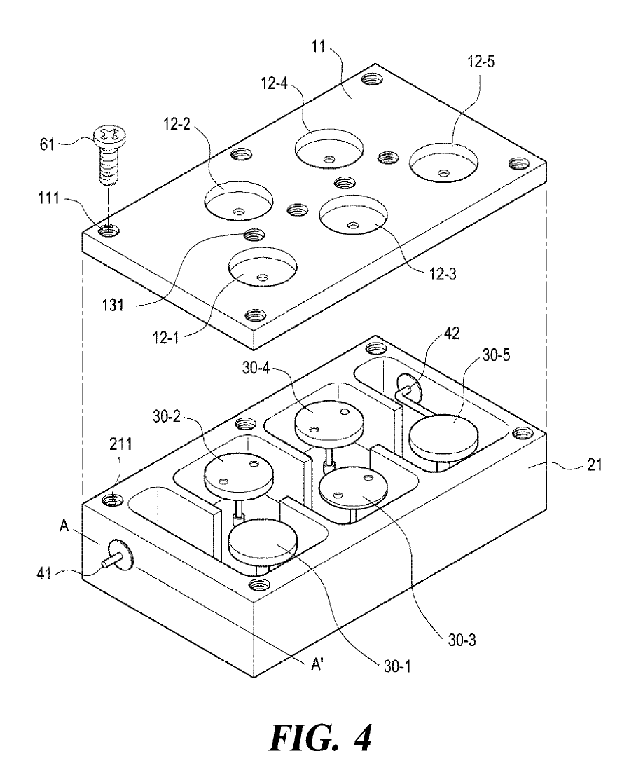

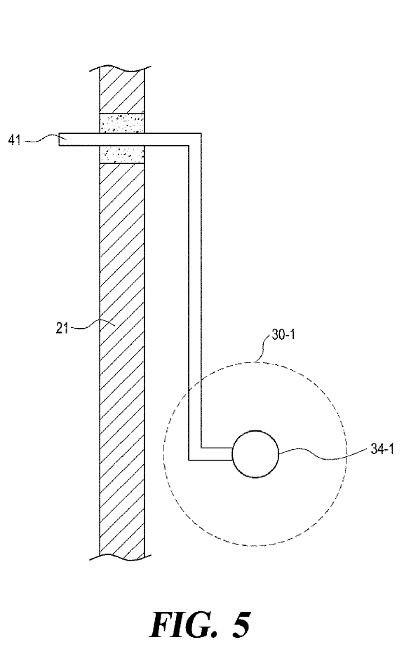

FIG. 4 is a partially exploded perspective view of a radio frequency filter having a cavity structure according to a second embodiment of the present disclosure. Referring to FIG. 4, the radio frequency filter having a cavity structure according to the second embodiment of the present disclosure is provided with an enclosure that has a hollow interior and a plurality of (five in the example of FIGS. 4 and 5) cavities isolated from the outside. The enclosure is formed including a housing 21 that has five cavities and an opening on one side (e.g., the upper side), and a cover 11 for shielding the open side of the housing 21.

In FIG. 4, an example case is shown where, for example, five cavity structures are shown connected in multiple stages in the housing 21. In other words, it can be regarded as a structure in which five cavity structures are sequentially interconnected. The cavities of the housing 22 have resonance elements 30-1, 30-2, 30-3, 30-4 and 30-5 centrally thereof, respectively. In addition, in order to make the respective cavity structures of the housing 21 have a sequentially coupled arrangement therebetween, coupling windows are provided in the form of connecting passages between the cavity structures having the sequential interconnection structures. The coupling windows may be provided at portions corresponding to partition walls between the cavity structures with a predetermined area of the portions removed.

In the configuration shown in FIG. 4, at least some of the resonance elements 30-1, 30-2, 30-3, 30-4 and 30-5 may have the structure according to the first embodiment of the present disclosure shown in FIGS. 1 to 3. For example, each of the second, third and fourth resonance elements 30-2, 30-3, 30-4 has a planar portion having a circular planar shape, and a support structure as shown in FIGS. 1 to 3. The planar portion is formed with at least two through holes, and the support may be structured to be fixed to the bottom surface of the housing by a screw fastening method.

FIG. 4 shows that, for example, the second and fourth resonance elements 30-2, 30-4 have, like the structure shown in FIGS. 1 to 3, extensions formed extending downward along the sides of the cavity from the side edges of the planar portions, while the third resonance element 30-3 has no such extension. In addition, the first and fifth resonance elements 30-1, 30-5 may have a typical resonance element structure. As described above, in some embodiments of the present disclosure, resonance elements having a typical structure may be used together with resonance elements having the structure shown in FIGS. 1 to 3. It is understood that, in other embodiments of the present disclosure, all resonant elements may have the same structure as that shown in FIGS. 1 to 3.

Meanwhile, the cover 11 may be formed with first to fifth depression structures 12-1, 12-2, 12-3, 12-4 and 12-5 for frequency tuning corresponding to the respective resonant elements in their cavity structures. The cover 11 may be additionally formed with a plurality of coupling/tuning threaded holes 131 at positions in the cover 11 corresponding to coupling windows, which are connection path structures between the respective cavity structures of the housing 21. A coupling/tuning screw (not shown) for tuning the coupling may be inserted into the coupling/tuning threaded hole 131 at an appropriate depth, so as to allow performing the tuning work of the coupling. At this time, the coupling tuning screw may be fixed in the proper position by using separate adhesive such as epoxy resin.

The cover 11 and the housing 21 may be fastened together by a screw fastening method with fastening screws 61. For example, through holes 111 for screw fastening are formed at appropriate positions of the cover 11, and a plurality of recesses 211 for screw fastening is formed in the housing 21 at portions corresponding to the through holes 111. The cover 11 and the housing 21 may be coupled by driving the fastening screws 61 through the through holes 111 of the cover 11 into the recesses 211 of the housing. It is understood that the cover 11 and the housing 21 may also be joined by laser welding, soldering or the like.

Further, as shown in FIG. 4, the radio frequency filter may have an input terminal 41 and an output terminal 42 attached thereto via through holes each formed on a lateral side of the housing 21 so that the terminals 41, 42 are respectively connected to the cavity structure at the input end and the cavity structure at the output end. FIG. 5 shows the input terminal 41 and the first resonance element 30-1 when they are fastened together in a manner that an extension line of the input terminal 41 is directly connected to a support 34-1 of the first resonance element 30-1. It is understood that the radio frequency filter may be configured so that the extension line of the input terminal is connected to a support 34-1 by a non-contact coupling method.

As described above, a radio frequency filter having a cavity structure is configured according to some embodiments of the present disclosure, although there are various other embodiments and modifications in the present disclosure. For example, in the above description, the number of through holes formed in the planar portion of the resonant element is two, but different numbers of through holes such as three or four of them may be formed in different configurations of the radio frequency filter.

In the second embodiment, for example, a filter structure is disclosed as having five cavities, although other filter structures may be configured to have two to four or more than six cavities. It is understood that, as is relevant to the filter structure, at least one or more resonant elements may be implemented as necessary so as to have the structure according to the first embodiment.

As described above, there are various modifications and alterations of the present disclosure, and therefore, the scope of the present disclosure is not defined by the embodiments described, but by the claims and the equivalence of the claims.

1. A radio frequency filter having a cavity structure, the radio frequency filter comprising:
a housing configured to have a hollow interior for providing at least one cavity and an open side;
a cover configured to shield the open side of the housing; and
at least one resonance element positioned in a hollow interior of the housing and having a planar portion and a support fixed to the housing and supporting the planar portion,
wherein the planar portion of the at least one resonance element has at least two through holes formed so as to be connected to an external driver device and rotate a corresponding resonance element, and the support has a lower end portion formed with a male thread structure for screw fastening, and
wherein the housing is formed with a female thread structure to be screw fastened with the male thread structure formed at the lower end portion of the support for fixing the support.

2. The radio frequency filter of claim 1, wherein the external driver device comprises:
at least two pins configured to be at positions corresponding to the at least two through holes formed in the planar portion, and to be inserted in the at least two through holes for an engagement with the at least two through holes.

3. The radio frequency filter of claim 1, wherein the planar portion has a thickness of 0.5 mm or less.

4. The radio frequency filter of claim 1, comprising a plurality of cavities and a resonance element provided for each of the plurality of cavities.

5. The radio frequency filter of claim 1, wherein the resonance element is made of a material having a coefficient of thermal expansion lower than a coefficient of thermal expansion of a material constituting the housing.

6. The radio frequency filter of claim 1, wherein the cover has at least one depression structure at a portion of the cover, corresponding to the resonance element for allowing a frequency tuning, the depression structure having a plurality of dot peens formed by an external marking device.

7. The radio frequency filter of claim 2, wherein the resonance element is made of a material having a coefficient of thermal expansion lower than a coefficient of thermal expansion of a material constituting the housing.

8. The radio frequency filter of claim 3, wherein the resonance element is made of a material having a coefficient of thermal expansion lower than a coefficient of thermal expansion of a material constituting the housing.

9. The radio frequency filter of claim 4, wherein the resonance element is made of a material having a coefficient of thermal expansion lower than a coefficient of thermal expansion of a material constituting the housing.

10. The radio frequency filter of claim 2, wherein the cover has at least one depression structure at a portion of the cover, corresponding to the resonance element for allowing a frequency tuning, the depression structure having a plurality of dot peens formed by an external marking device.

11. The radio frequency filter of claim 3, wherein the cover has at least one depression structure at a portion of the cover, corresponding to the resonance element for allowing a frequency tuning, the depression structure having a plurality of dot peens formed by an external marking device.

12. The radio frequency filter of claim 4, wherein the cover has at least one depression structure at a portion of the cover, corresponding to the resonance element for allowing a frequency tuning, the depression structure having a plurality of dot peens formed by an external marking device.
